(19) United States
(12) Patent Application Publication
(10) Pub. No.: US 2002/0057235 A1
(43) Pub. Date: May 16, 2002

(54) Display device

(76) Inventors: Tetsuya Murai, Saitama-ken (JP); Jun Hanari, Kanagawa-ken (JP)

Correspondence Address: PILLSBURY WINTHROP LLP, 1600 TYSONS BOULEVARD, MCLEAN, VA, 22102, US

(21) Appl. No.: 09/987,710

(22) Filed: Nov. 15, 2001

(30) Foreign Application Priority Data
Nov. 15, 2000 (JP) 2000-347732

(51) Int. Cl. G09G 3/34

(52) U.S. Cl. 345/84

(57) ABSTRACT

A display device includes a display panel and a flexible printed circuit board. The display panel includes a plurality of pixels which have an insulation substrate, a plurality of first electrodes disposed on the insulation substrate in a matrix form, a second electrode provided opposite to the first electrodes and an optical modulation layer held between the first and second electrodes, and driving circuits integrated on the insulation substrate to drive the pixels. A connecting portion of the printed circuit board is fixed on a main surface of the insulation substrate to supply electrical signals to the display panel. The flexible printed circuit board is provided on a non-display side of the display panel and a part of the other portion than the connecting portion is fixed on the display panel.

### CROSS-REFERENCE TO RELATED APPLICATIONS

This application is based upon and claims the benefit of priority from the prior Japanese Patent Application No. 2000-347732, filed on Nov. 15, 2000, the entire contents of which are incorporated herein by reference.

### BACKGROUND OF THE INVENTION

1. Field of the Invention

The present invention relates to a display device with an optical modulation layer held between electrodes and, more particularly, to a liquid crystal display device or a self-luminous type display device.

2. Description of the Related Art

A conventional liquid crystal display device is shown in FIG. 5. The liquid crystal display device includes a display panel 1, a driving circuit board 2 to drive the display panel 1, a flexible printed circuit board 3, a driver IC unit 4 provided on the flexible printed circuit board 3, and a surface light source 5 to illuminating the display panel 1 The surface light source 5 is generally provided with a cold cathode fluorescent lamp 51, a light guide 52, a reflector 53, a light diffuser 54 and the like. The surface light source 5 is fixed on the display panel 1 by a frame 8.

The display panel 1 includes an array substrate, a counter substrate, and the liquid crystal layer held between these substrates. The array substrate is made of a transparent insulation material on which signal lines, scanning lines, thin film transistors (TFTs), display electrodes and the like are formed. The counter substrate is disposed opposite to the array substrate and made of a transparent insulation material on which a counter electrode commonly used for the pixels and the like are formed. In the display panel 1, a plurality of display elements include a liquid crystal layer held between the display and common electrodes for an optical modulation and are disposed in a matrix form.

An equivalent circuit of the display panel 1 of the liquid crystal display device is shown in FIG. 6. Signal and scanning lines 11 and 12 cross each other and a thin film transistor (TFT) 13 is connected as an active element at a crossing portion of the signal and scanning lines 11 and 12. The TFT 13 is electrically connected to loads: a liquid crystal layer functioning as an optical modulator 19 and a capacitor 20. The source and drain electrodes 14 and 15 of the TFT 13 are electrically connected to the signal line 11, and the display electrode 17 and the electrode of the capacitor 20, respectively. The gate electrode 16 of the TFT 13 is connected to the scanning line 12. The liquid crystal layer is held between the display and counter electrodes 17 and 18. When a predetermined positive voltage pulse Vg is applied to the gate electrode 16 of the TFT 13 through the scanning line 12, the TFT 13 turns on so that a signal voltage Vs passes from the source electrode 14 to the drain electrode 15 and is supplied to the liquid crystal layer 19 and the capacitor 20.

The driving circuit board 2 to supply a driving signal to the display panel 1 is disposed on the back side of the surface light source 5 by using flexibility of the flexible printed circuit board 3.

FIG. 7 shows an unfolded view of a liquid crystal display device with a screen size of 10 to 15 inches. The driving circuit board 2 consists of a signal line driving circuit board 2A to drive the signal line and a scanning line driving circuit board 2B to drive the scanning line. A plurality (from 8 to 10) of the flexible printed circuit boards 3 equipped with driver IC devices 4 (called hereinafter tape carrier packages) are provided to connect the display panel 1 to the signal line driving circuit board 2A. A plurality (from 3 to 5) of tape carrier packages are also provided to connect the display panel 1 to the scanning line driving circuit board 2B. Further, a flexible printed circuit board 6 is connected to the signal line driving circuit board 2A to read in outer signals. A flexible printed circuit board 61 is provided to connect the signal line driving circuit board 2A to the scanning line driving circuit board 2B.

Since connecting terminals of the tape carrier packages to connect the flexible printed circuit boards 3 to the display device 1 are extremely small in pitch, e.g., 65 μm to 110 μm, an anisotropic conductive film is used to connect the printed circuit boards 3 to the display panel 1. Since, however, such connecting terminals of the tape carrier packages to connect the driving circuit board 2 to the flexible printed circuit boards 3 are rather wide inpitch, e.g., 0.4 mm to 1 mm, there is often used a soldering material in addition to an anisotropic conductive film to connect the driving circuit board 2 to the flexible printed circuit boards 3. Further, a removable connector is used to connect the driving circuit board to outside components

In the conventional liquid crystal display device explained above, since many flexible printed circuit boards 3 are used to connect the driving circuit board 2 to the display panel 1, pressure-contacting steps are necessary to contact the panel 1 to the flexible printed circuit boards 3 and the driving circuit board 2 to the flexible printed circuit boards 3, respectively, in their assembling process. These steps each are completed by one operation in some cases but more operations are required for each of them in many cases as the sizes of display panel increase to comply with recent market demands so that they cause the assembling process much longer time.

In addition, since the number of connecting terminals a flexible printed circuit board 3 assigned to the display panel 1 is more than the range from 300 to 400, it often results in improper contacts at the connecting terminals or a decline in their reliability. Further, the flexible printed circuit board 3 with the driver IC unit 4 and its materials are expensive.

The driving circuit board 2 is disposed at the back portion of the frame 8 to support the surface light source 5. Since the thickness of the driving circuit board 2 and that of circuit components equipped thereon increase the total thickness of the display panel 1, such a structure of the conventional display device has the disadvantage to make the display device thin in thickness.

External force, such as a strain stress, applied to the flexible printed circuit board 3 may peel away its connecting portion and possibly cause such troubles that the connecting portion is broken down.

Meanwhile, a display panel in an organic self-luminous type display device (not shown) includes a plurality of anodes disposed in a matrix form on a transparent substrate, cathodes provided opposite to the anodes, and a laminated layer of a luminous layer held between the anodes and the cathodes as a light modulation layer and the like. Such a luminous type display device is unnecessary to have a surface light source but necessary to have a driving circuit board 2 and a flexible printed circuit board 3. To this extent, it has substantially the same technical problems to be solved as the conventional liquid crystal display device does.

### SUMMARY OF THE INVENTION

The present invention is made to solve those technical problems.

An object of the present invention is to provide a display device with substantially no connecting trouble at its connecting portions to supply a display panel with an electrical signal.

Another object of the present invention is to provide a display device which is relatively easily assembled, highly reliable, less expensive, thin, and light-weight.

A first aspect of the present invention is directed to a display device with a display panel and a flexible printed circuit board. The display panel includes an insulation substrate with two main surfaces opposite to each other, pixels, and driving circuit integrated with the pixels on the insulation substrate to drive the pixels. The pixels are provided with a plurality of first electrodes disposed on one main surface of the insulation substrate in a matrix form, second electrodes disposed opposite to the first electrodes, and a light modulation layer held between the first and second electrodes, and driving circuits integrated with the pixels on the insulation substrate to drive said pixels. The flexible printed circuit board includes an electrically connecting portion fixed on a non-display surface of the two main surfaces of the insulation substrate to supply the display panel with electrical signals, and at least a part of the other portion than the connecting portion fixed on a display surface of the two main surfaces.

A second aspect of the present invention is directed to a display device characterized in that the optical modulation layer is a liquid crystal layer.

A third aspect of the present invention is directed to a display device characterized in that the optical modulation layer is an organic luminous layer.

A fourth aspect of the present invention is directed to a display device characterized in that the part of the other portion than the connecting portion is fixed on the display surface of two main surfaces by a double-faced adhesive tape.

A fifth aspect of the present invention is directed a display device includes an optically transparent display panel, a flexible printed circuit board, and a surface light source. The display panel also includes a plurality of pixels and driving circuits integrated with the pixels on the transparent substrate to drive the pixels. The pixels are provided with a first transparent substrate, a plurality of first electrodes disposed on the first transparent substrate in a matrix form, a second transparent substrate provided opposite to the first transparent substrate, a second electrode disposed on the second substrate, and a liquid crystal layer held between the first and second substrates. The flexible printed circuit board is fixed on one of the first and second transparent substrates to transmit electrical signals to the display panel. The surface light source is provided on a non-display side of the display panel. The display device is characterized in that the flexible printed circuit board is bent toward a back side of the surface light source and at least a part of the flexible printed circuit board bent toward the back side of the surface light source is fixed on the surface light source.

The above-stated and other objects and advantages of the invention will become apparent from the following description when taken with the accompanying drawings. It will be understood, however, that the drawings are for purposes of illustration and are not to be construed as defining the scope or limit of the invention, reference being had for the latter purpose to the claims appended hereto.

### BRIEF DESCRIPTION OF THE DRAWINGS

FIG. 1 shows schematically a cross section of a main unit of a liquid crystal display device as a first embodiment in accordance with the present invention;

FIG. 2 is a perspective view of a panel with a portion partially cut out in the liquid crystal display device shown in FIG. 1;

FIG. 3 shows schematically a cross section of a main unit of a liquid crystal display device as a second embodiment in accordance with the present invention;

FIG. 4 shows schematically a side view of a liquid crystal display device as a third embodiment in accordance with the present invention;

FIG. 5 shows schematically a cross section of a conventional liquid crystal display device;

FIG. 6 is an equivalent circuit diagram of a pixel in a liquid crystal display panel of a liquid crystal display device;

FIG. 7 Is an unfolded plan view of the liquid crystal display device shown in FIG. 5;

FIG. 8(a) shows a block diagram of a liquid crystal display device according to the present invention;

FIG. 8(b) is signals supplied from an outside connector to input terminals of a panel in the liquid crystal display device shown in FIG. 8(a);

FIG. 9 is a block diagram of an organic self-luminous type display device of the present invention;

FIG. 10 is an equivalent circuit of one pixel in an organic electro-luminescence (EL) display panel of a fourth embodiment of the present invention;

FIG. 11 is a schematic sectional view of the display device in accordance with the fourth embodiment; and

FIG. 12 is a schematic sectional view of an organic self-luminous type display device as a modified embodiment of the present invention.

### DETAILED DESCRIPTION OF THE INVENTION

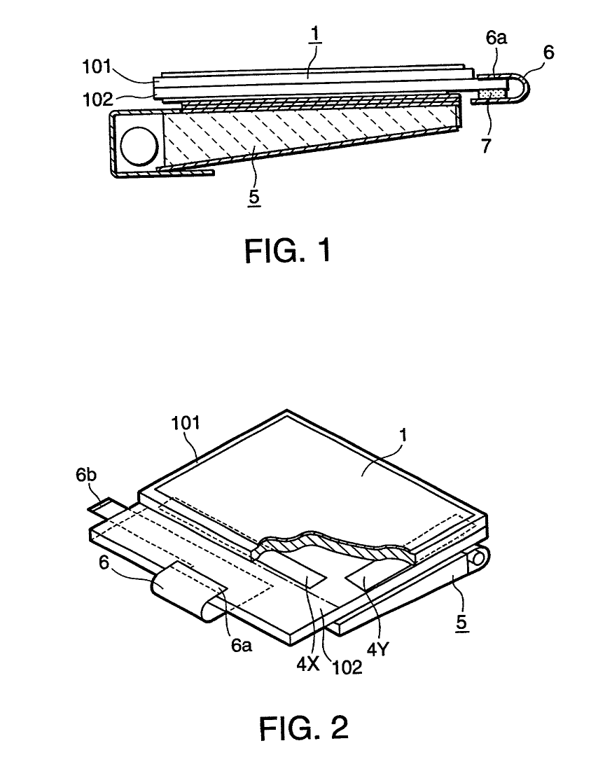

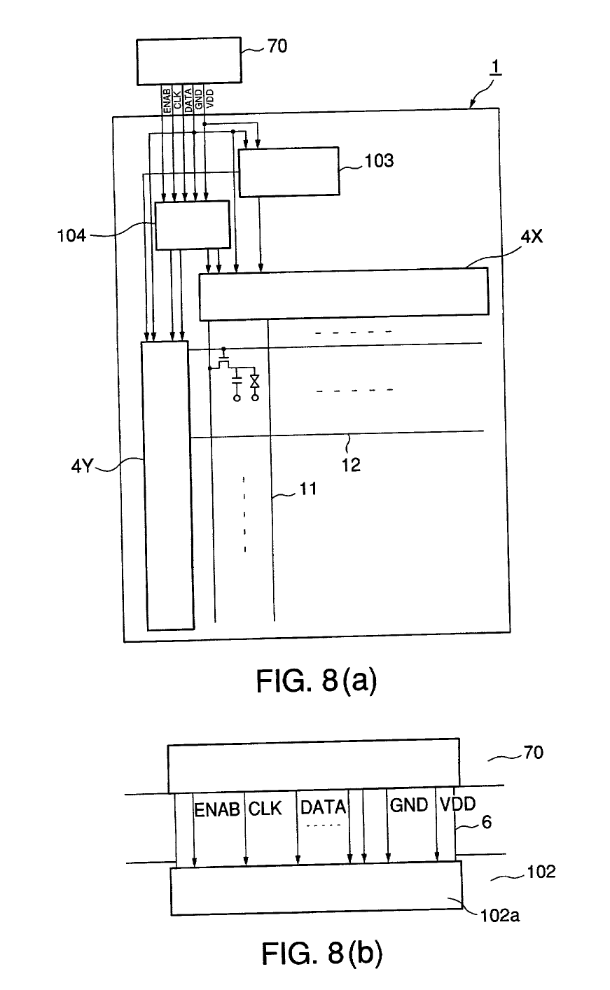

The present invention will be described hereinafter in detail with reference to the attached drawings. FIG. 1 shows schematically a first embodiment of a liquid crystal display device in accordance with the present invention. FIG. 2 is a perspective view of a display panel with a portion partially cut out in the liquid crystal display device shown in FIG. 1. FIG. 8(a) and 8(b) show a schematic diagram of a liquid crystal display device and a block diagram of a connector of the display panel and a signal source connected thereto. Like reference characters designate like or corresponding components throughout the drawings and explanation thereof is omitted.

The liquid crystal display device includes an optically transparent type display panel 1, a surface light source 5 disposed on a non-display side of the panel 1 and a flexible printed circuit board 6 electrically connected to the panel 1. The display panel 1 is provided with a array substrate 102, a counter substrate 101 disposed opposite to the array substrate 102. Since thin film transistors (TFTs) integrated on the array substrate consist of high mobility semiconductors, such as poly silicon films, a signal line driving circuit 4X and a scanning line driving circuit 4Y are also integrated with such TFTs on the transparent insulation material of the array substrate. The driving circuits 4X and 4Y are disposed at portions adjacent to coating areas of sealant to put the array substrate together with the counter substrate and seal them.

At the extended portion of the array substrate 102 from the counter substrate 101, there are equipped signal input terminals 102a to receive signal from outside components (signal source) and an interface control circuit to process the signals from the input terminals 102a and distribute the processed signals to the signal line driving circuit 4X and the scanning line driving circuit 4Y.

Signals supplied from the outside component and the interface control circuit will be explained in detail herein below.

Signals from an outside signal source 70, such as a personal computer, are supplied to the display panel 1 through a flexible printed circuit board 6. Such signals are composed of a 3.3-volt power source voltage VDD, for instance, a reference voltage GND, display data DATA in a 6-bit digital form for each of red R, green G and blue B, a synchronization (control) signal ENBA, and a clock signal CLK. Two inputs which are a pair of power source voltages VDD and GND, 18 display data DATA inputs, one synchronization signal ENAB, and one clock signal CLK (22 inputs in total) are supplied to the display panel 1 through the flexible printed circuit board 6.

The interface control circuit includes a DC/DC converter 103 and a controller 104. The converter generates various power source voltages (15V, 10V, 5V, −2V, 23V, −10V, 9V and −6V, for example) necessary to drive the display panel 1 from the power source voltage VDD, GND supplied from the outside components. The controller 104 generates a control signal to drive the display panel in response to data supplied from the signal source 70 and the synchronization signal ENAB, and carries out digital processing of the display data DATA, such as rearrangements of the display data DATA.

The signal line driving circuit 4X formed on an insulation material of the array substrate includes a D/A converter, an output circuit and a sampling circuit. The D/A converter changes the display data in a digital form to the one in an analog form and provides it to the output circuit. The output circuit has an amplifier or an amplifier and a buffer circuit which process the analog form display signal. The output circuit outputs such processed signal as an analog video signal. The sampling circuit then samples the video signal and supplies it to a signal line 11.

The scanning line driving circuit 4Y includes a shift register consisting of a plurality of flip-flop circuits, and an output circuit. A previous stage flip-flop circuit in the shift register transfers to its next stage flip-flop circuit a start pulse supplied from the controller 104. The output circuit provides an output signal of each flip-flop circuit to the scanning line 12 as a scanning signal. Each display element is driven in response to the video signal provided through a TFT 13 when the TFT is selected by the scanning signal.

As explained above, since the signals supplied from the outside signal source 70 are composed of a pair of the power source voltages VDD, the reference voltage GND, the display data DATA, the clock signal CLK and the synchronization signal ENAB only and various signals to drive the display panel 1 are generated in the inside of the array substrate 102, the number of contacting points between the array substrate 102 and the outside signal source 70 may be significantly reduced.

Although the composite synchronization signal is used as a synchronization signal and is supplied to one input terminal in the present embodiment, the present invention is not limited to it because a plurality of synchronization signals may be used to take substantially the same effect as in the present embodiment.

In addition, the number of power source inputs may be more than two and compensatory power inputs may also be supplied from outside components.

Since the DC/DC converter 103 may be a high voltage generating circuit by making use of a charge pump circuit formed on the insulation material of the array substrate 102, only a lower voltage may be supplied through the flexible printed circuit board 6. Wires in the flexible printed circuit board 6 are lower in electric resistance than those formed on a glass substrate. Thus, such wires in the flexible printed circuit board 6 are possibly made longer where connecting portions between the power source and the glass substrate (the insulation material) are disposed in the most suitable place on the glass substrate. According to the present embodiment, it is possible to make greater the degree of freedom to arrange connecting portions at suitable locations on either side of the signal source or the display panel. Thus, it is also possible to make the degree of freedom to design a display device greater.

The signal input terminals 102a of the array substrate 102 are fixed and connected to the flexible printed circuit board 6 by applying an anisotropic conductive film thereto. Thus, an outer signal is supplied to the signal line driving circuit 4X and the scanning line driving circuit 4Y through the flexible printed circuit board 6. The flexible printed circuit board 6 is bent around the edge portion of the insulation material of the array substrate 102 to the back side thereof at 180° and fixed on the back surface of the insulation material by a double-faced adhesive tape 7.

With this structure, since at least a part of the flexible printed circuit board is fixed on a non-display surface, it substantially prevents direct stress from applying to the portions connecting the display panel to the flexible printed circuit board when removing the flexible printed circuit board from an outer connector of the signal source 70 and also prevents the connecting portions from breaking lines and/or pealing off.

Since the signal line driving circuit 4X and the scanning line driving circuit 4Y are formed on the display panel 1 and the interface circuit is integrated with them, the number of input signal lines connected to the display panel 1 are reduced. The number of terminals connecting the flexible printed circuit board 6 to the display panel 1 becomes extremely small and that of the flexible printed circuit board 6 can be one. In the case of a liquid crystal display device with 15-inch display size and XGA mode (1,024 ×768 pixels), for instance, the number of terminals connecting the display panel 1 to signal output terminals of the flexible printed circuit board 6 may be 20 to 30 compared to about 4,000 in the case of a prior art liquid crystal display device. If the number of the connecting terminals can be reduced remarkably, the connecting portion does not have substantial restrictions on its occupied area and the pitch between terminals can be made wide. As a result, the accuracy of assembling those components can be eased, short circuit troubles between the terminals caused by foreign materials can be reduced at assembling, and the productivity and yield rate are improved significantly. Further, the number of wires of the flexible printed circuit board are greatly reduced so that the breaking or snapping of the wires can be avoided when the flexible printed circuit board is bent back and so that the flexible printed circuit board is strong against a large bending curvature.

Further, the number of terminals connecting the display panel 1 to the outside components is also extremely reduced and that of assembling steps is further reduced. In the case of the liquid crystal display device with 15-inch display size and XGA mode set forth above, for instance, it takes 300 seconds or so in total to connect the display panel 1 to a plurality of the flexible printed circuit boards 6 and to connect the flexible printed circuit board 6 to the driving circuit board 2 in the prior art liquid crystal display device but it takes only about 20 seconds and can save about 280 seconds in the first embodiment of the present invention because it is only necessary to connect the signal input terminals of the display panel 1 to the signal output terminals.

In this embodiment, since it is unnecessary to provide a flexible printed circuit board with a driver IC unit 4, material costs are less expensive.

Although the end portion of the flexible printed circuit board 6 bent around the edge portion of the insulation material of the array substrate 102 to the back side thereof at 180° is fixed to the back side of the material by the double-faced adhesive tape 7 in the first embodiment, other adhesive materials may be used and only a part of the end portion may be adhered to the back side of the material.

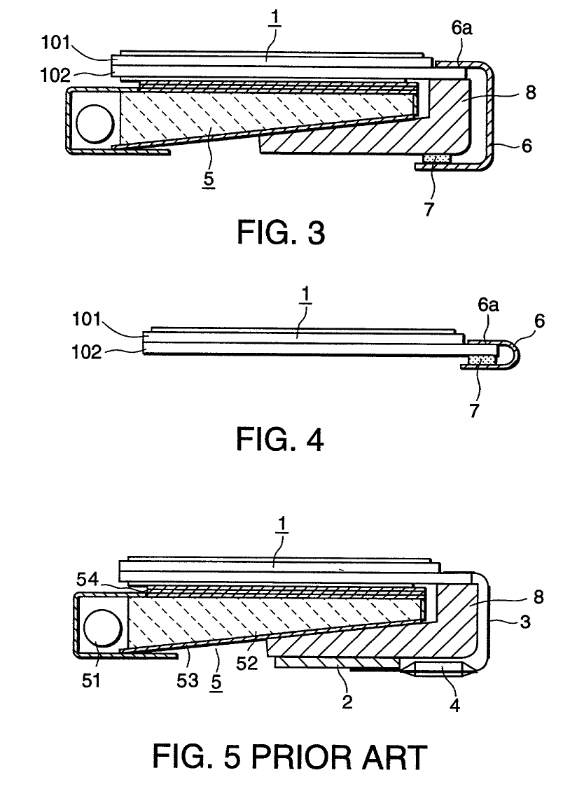

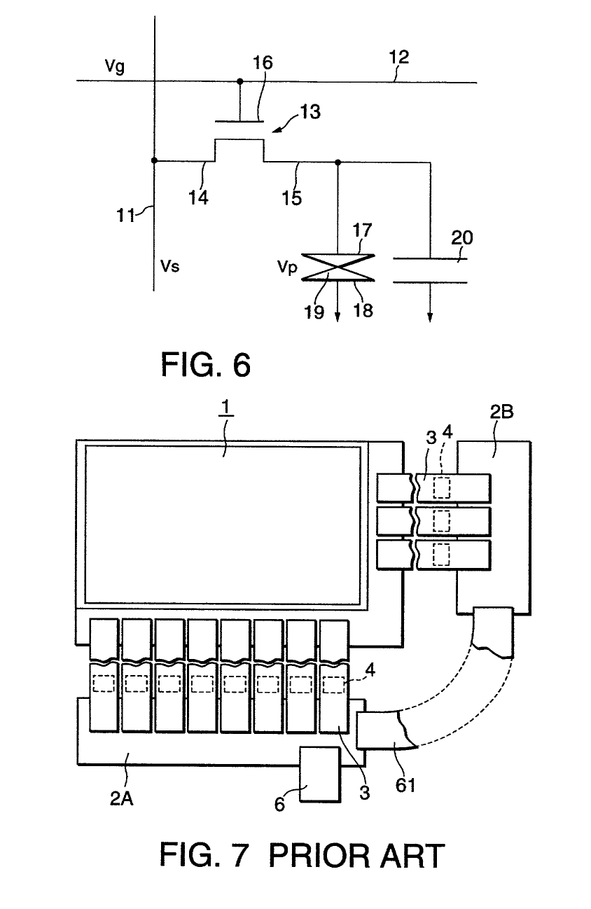

A schematic cross section of major components for a liquid crystal display device are shown in FIG. 3 as a second embodiment of the present invention. By way of example, a fixing place of a flexible printed circuit board in this embodiment is different from the one of the first embodiment shown in FIGS. 1 and 2 in order to reduce stress applied to the connecting portion of the flexible printed circuit board. Such a structure only different from the previous embodiment will be explained hereinafter. As set forth above, the surface light source 5 is assembled with a frame 8. The signal output terminal 6a of the flexible printed circuit board 6 is fixed to the signal input terminal of the display panel 1 by the isotropic conductive layer and the flexible printed circuit board 6 is bent to the back side of the surface light source 5. Further, the end portion of the flexible printed circuit board 6 is fixed to the frame 8 on the non-light projecting side of the surface light source 5 by the double-faced adhesive tape 7. This structure causes substantially the same effect or advantage as in the first embodiment.

Although the end portion of the flexible printed circuit board 6 bent around the edge portion of the surface light source 5 to the back side thereof at 180° is fixed to the back side of the surface light source 5 by the double-faced adhesive tape 7 in the second embodiment, substantially the same advantages as that structure has may be achieved by the following alternative: other adhesive materials are used, only a part of the end portion is adhered to the back side of the surface light source 5 or the end portion is fixed by engaging it with a projection formed on the frame 8.

Now referring to FIG. 4, there is shown a side view of an optically reflective type liquid crystal display device as a third embodiment of the present invention. The non-display surface of the display panel 1 or the display electrode 17 is provide with a reflectivity to illuminate the display panel 1 sufficiently by using ambient light.

The flexible printed circuit board 6 connected to the display panel 1 is bent around one edge portion of an insulation material to the non-display side of the display panel 1 at 180° and a part of the printed circuit board 6 is fixed to the back side of the array substrate 102 by the double-faced adhesive tape 7.

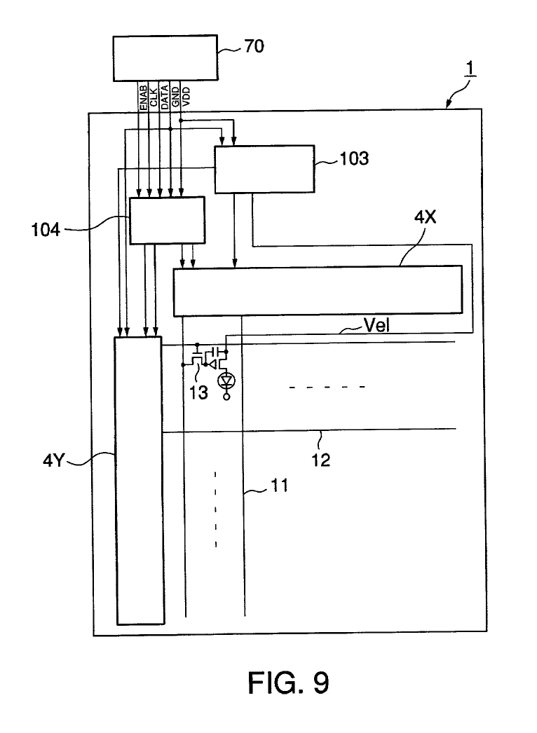

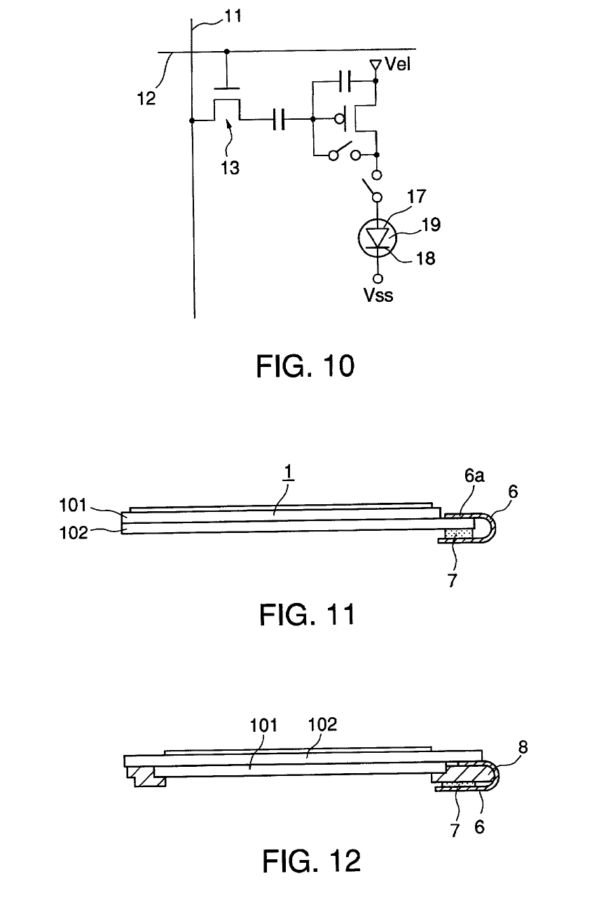

Next, an organic self-luminous type display device will be explained as a fourth embodiment of the present invention. FIGS. 9, 10 and 11 show a schematic block diagram of an organic self-luminous type display device, an equivalent circuit of one pixel, and a schematic sectional view of the display device, respectively. A display panel 1 of this organic self-luminous type display device includes an array substrate 102 and a counter substrate 101. The counter substrate 101 is made of a transparent material and provided opposite to the array substrate. The array substrate includes a plurality of first electrodes 17 and a second electrode 18 provided opposite to the first electrodes 17 and a light modulation layer 19, such as a laminated layer of at least a luminous layer, disposed between the first and second electrodes 17 and 18 to define display elements in a matrix form. The array substrate is provided with a signal line driving circuit 4X, a scanning line driving circuit 4Y and an interface control circuit at its edge portions. To signal input terminals 102a of the display panel 1 signal output terminals 6a are connected to dispose the flexible printed circuit board 6 at a non-display area of the display panel 1. At least a part of the flexible printed circuit 6 is fixed at a non-display portion on the back side of the array substrate by a double faced adhesive tape. This embodiment can have such advantages as set forth above.

Other adhesive components than a double-faced adhesive tape may be also used to fix the flexible printed circuit board on the back side of the insulation substrate. A part of the flexible printed circuit board may be pressed by a single-faced adhesive tape, for instance, to fix the same on the insulation material.

Alternatively, as shown in FIG. 12, a frame 8 may be disposed on the back side of a display panel 1 to expose the display side of the display panel 1 and may be fixed to a flexible printed circuit board 6 on the non-display side of the display panel 1.

As set forth above, since a flexible printed circuit board is also fixed at other portions than a connecting portion, stresses applied to the connecting portion can be substantially reduced. Thus, it prevents the connecting portion of the display device from breaking down and/or peeling off.

The present invention provides a display device with improper connection to outer components substantially reduced. According to the present invention a display device is easily assembled, highly reliable, less expensive, and light in weight.

What we claim is:

1. A display device comprising:
[I] a display panel including,
(1) an insulation substrate,
(2) pixels including,
a) a plurality of first electrodes disposed on one main surface of said insulation substrate in a matrix form,
b) second electrodes provided opposite to said first electrodes, and
c) an optical modulation layer held between said first and second electrodes, and
(3) driving circuits integrated with said pixels on said one main surface of said insulation substrate to drive said pixels; and
[II] a flexible printed circuit board having
(1) an electrically connecting portion fixed on said one main surface of said insulation substrate to supply said display panel with electrical signals, and
(2) at least a part of the other portion than said connecting portion fixed on a non-display surface of said insulation substrate.

2. A display device according to claim 1, wherein said optical modulation layer is a liquid crystal layer.

3. A display device according to claim 1, wherein said optical modulation layer is an organic luminous layer.

4. A display device according to claim 1, wherein said part of the other portion than said connecting portion is fixed on the non-display surface of said insulation substrate by an adhesive tape, both surfaces of which are coated with adhesive materials.

5. A display device comprising:
[I] a display panel including,
(1) a plurality of pixels including,
a) a first transparent substrate,
b) a plurality of first electrodes disposed on said first transparent substrate in a matrix form,
c) a second transparent substrate provided opposite to said first transparent substrate,
d) a second electrode disposed on said second substrate, and
e) an optical modulation layer held between said first and second transparent substrates, and
(2) driving circuits integrated on said first transparent substrate to drive said pixels;
[II] a flexible printed circuit board fixed on said first transparent substrate to transmit electrical signals to said display panel; and
[III] a frame provided on a non-display side of said display panel,
wherein said flexible printed circuit board is bent toward a back side of said frame and at least a part of said flexible printed circuit board bent toward said back side of said frame is fixed on said frame.

6. A display device comprising:
a display panel including;
a display area having a plurality of pixels provided in a matrix form,
a signal input terminal disposed on a first surface of the display panel, and
driving circuits integrated on said first surface; and
a flexible printed circuit board having,
a signal output terminal fixed to the signal input terminal, and
at least a part of said flexible printed circuit board fixed on a second surface of said display panel.
